(19) United States
(12) Patent Application Publication
(10) Pub. No.: US 2002/0170961 A1
(43) Pub. Date: Nov. 21, 2002

(54) Method and system for providing shopping assistance using RFID-tagged items

(76) Inventors: Bruce Dickson, Apex, NC (US); Mary Louise Dickson, Apex, NC (US)

Correspondence Address: Esther H. Chong, Esquire, Synnestvedt & Lechner LLP, 2600 Aramark Tower, 1101 Market Street, Philadelphia, PA, 19107-2950, US

(21) Appl. No.: 09/859,292

(22) Filed: May 17, 2001

(51) Int. Cl. G06K 15/00

(52) U.S. Cl. 235/383

(57) ABSTRACT

A method and system for providing shopping assistance to a customer. The system provides a shopping cart attachment device attached to a shopping cart operated by the customer, and RFID-tagged items. The shopping cart attachment device is configured to automatically detect items as they are placed in (or removed from) the shopping cart, to automatically scan the RFID-tagged item information, and to communicate the scanned item information to a central processing system. The central processing system identifies recommended additional purchase items associated with the items placed in the shopping cart based on the RFID-tagged item information, and displays this recommended information on the display device of the customer's wireless communication device such as a PDA, a two-way pager, a mobile phone, etc.

### BACKGROUND OF THE INVENTION

1. Field of the Invention

The present invention relates to shopping assistance systems and, more particularly, to a method and system for providing helpful shopping assistance to customers using RFID (Radio Frequency IDentification) tagged items.

2. Discussion of the Related Art

A variety of shopping assistance devices are known in the art for assisting customers with their shopping processes. For example, U.S. Pat. No. 5,918,211 issued to Sloane describes a shopping assistance system. In the Sloane system, a customer is provided with a portable bar code scanner which is mountable on a shopping cart. During a shopping process, the customer scans bar codes on all products placed in the customer's shopping cart. When the customer scans a product, a display device in the bar code scanner shows the product's price and any promotional information available for that product or a related product. After scanning the product, the customer can add the scanned product to the customer's current product total by pressing a “Plus” button provided on the scanner. If, however, the customer adds the scanned product to the running total and then changes his or her mind, then the customer must rescan the product and press a “Minus” button on the scanner to remove this product information from the running total. A final purchase receipt which identifies the total price of all items selected by the customer, is printed and provided to the customer when the customer completes his shopping and returns the bar code scanner to a cental location. The customer then takes this purchase receipt to a cash register to render payment for the selected items.

Problems, however, exist with the Sloane system. In the Sloane system, an act of scanning the bar codes on products is required by the customer if the customer desires to take advantage of promotions and coupons for these products. Further, all items placed in the shopping cart must be scanned and registered into the bar code scanner since the final purchase receipt generated based on the scanned information is used during the check-out process. This means that the customer must always remember to scan the item before he or she places it in the shopping cart. This process takes time and can be extremely inconvenient and tedious to the customer.

Furthermore, to minimize thefts and system abuse, the Sloane system provides an elaborate security system including a video camera attached to the bar code scanner so that any item scanned by the bar code scanner is also video-taped. However, this security system requires that someone is present to view the video tapes to monitor the customers' shopping behaviors. This requires additional manpower to implement the security system and increases the cost associated with the Sloane system.

Moreover, the customer must actuate the “Plus” and/or “Minus” buttons on the bar code scanner to add or remove products to or from the running total. If the customer changes his or her mind on certain purchase items, the customer must rescan such products and operate the Plus and/or Minus buttons to implement these changes. This process is complicated and can be confusing especially when there are a large number of items involved. It can increase data errors and a miscalculation of the running total price. Ultimately, this process interferes with the customer's shopping process and can deprive the customer of enjoying the shopping process.

Accordingly, there is a need for a method and system for providing shopping assistance to customers which overcomes the above-described problems and other problems encountered in conventional shopping assistance systems and methods.

### SUMMARY OF THE INVENTION

The present invention provides a method and system for providing shopping assistance to customers using RFID-tagged items, which overcomes the above-described problems and other problems encountered in conventional shopping assistance systems and methods.

Particularly, the present invention provides a shopping cart attachment device attached to a shopping cart operated by a customer at a store. Each item or product sold at the store includes a RFID tag for storing therein information about the item, such as the name of the manufacturer, the name and suggested price of the item, etc. The shopping cart attachment device is configured to automatically detect items as they are placed in (or removed from) the shopping cart and to automatically scan the RFID-tagged item information. The shopping cart attachment device communicates the scanned item information to a central processing system. The central processing system then makes intelligent shopping suggestions based on the scanned item information. For example, the central processing system may recommend additional purchase items that are associated with the items placed in the shopping cart. The shopping suggestions are displayed on the display device of a wireless communication device carried by the customer such as a PDA, a two-way pager, a mobile phone, etc. to assist the customer during his or her shopping process.

In addition, a check-out button or indicator is provided on the shopping cart attachment device or the customer's wireless communication device such as the PDA. The check-out button can be a button or switch physically located on these devices, or can be a computer-generated button (e.g., button displayed on a touch-sensitive screen) provided by these devices. The customer actuates the check-out button upon completion of the shopping process. In response to the actuation of the check-out button, the system determines which check-out lane is currently available to receive the customer and indicates that check-out lane information to the customer via the customer's wireless communication device. The customer then proceeds to the identified check-out lane and renders payment for the items in the customer's shopping cart.

Accordingly, the present invention provides shopping assistance to customers by providing intelligent shopping suggestions such as additional purchase items associated with the items placed in the shopping cart. Furthermore, no overt act of scanning the items is needed by the customer since the placement and removal of the items in and out of the shopping cart are detected automatically and the item information is read automatically by the operation of the RFID reader. This allows elimination of a separate security system such as a video camera used in prior art systems.

### BRIEF DESCRIPTION OF THE DRAWINGS

FIG. 1 is a diagram of a system for providing shopping assistance using RFID-tagged items according to one embodiment of the present invention.

FIG. 2 is a block diagram of the system shown in FIG. 1 according to one embodiment of the present invention.

### DETAILED DESCRIPTION OF THE PREFERRED EMBODIMENTS

In the drawings, the same reference numerals are used to indicate the same elements.

The present invention assumes that each of items/products sold at a store or a shopping area includes a conventional Radio Frequency IDentification (RFID) tag. Conventionally, manufacturers, retailers or distributers attach RFID tags to their merchandise so that they can track the movement of the merchandise without any direct contact with the items being monitored. A typical RFID tag on a product includes an antenna and a silicon chip containing modulation circuits, control logic and non-volatile memory. The silicon chip derives electrical power from radio signals received by the antenna or from a battery, and is able to exchange data with a RFID tag reader by demodulating and modulating the radio signals. A computer coupled to the RFID tag reader can read and write to and from the memory of the RFID tag using radio signal transmission. Generally, item information such as the name of the item, name of the manufacturer, the price of the item, etc., is stored in the RFID tag of a product. This information is often represented using one of the following:1) a retail SKU number (e.g , UPC—universal product code) representing the name, manufacturer and/or suggested price of the product, (2) a unique serial number representing the product, or (3) the SKU number and the unique serial number.

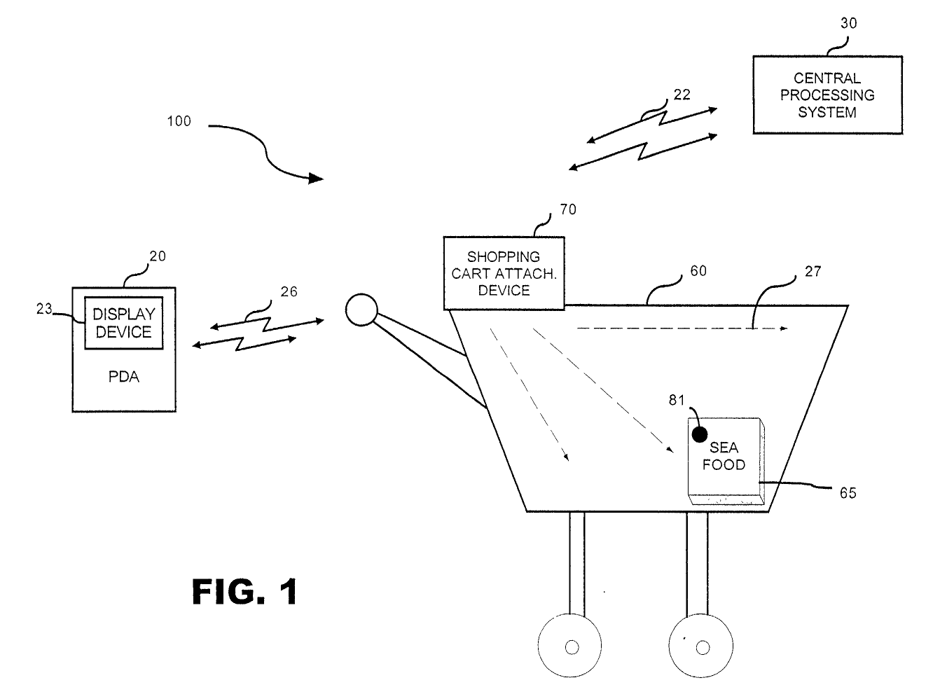

FIG. 1 is a diagram of a system 100 for providing shopping assistance using RFID-tagged items according to one embodiment of the present invention. The system 100 can be implemented in or for a store, shopping mall, or other shopping area or environment. As shown in FIG. 1, the system 100 includes at least one shopping cart attachment device 70 installed on a shopping cart 60 or any other shopping cart, a personal digital assistance (PDA) 20 including a display device 23 and carried by a user such as a customer, and a central processing system 30 for communicating with one or more shopping cart attachment devices in the system. These components are all operatively coupled.

The shopping cart attachment device 70 is configured to detect automatically RFID-tagged items (e.g., item 65 having a RFID tag 81) as they are placed in or removed from the customer's shopping cart 60. The attachment device 70 also reads automatically the RFID tags on these items by radio communication 27 and thereby obtains item information on the items placed in the shopping cart 60.

In addition, the shopping cart attachment 70 is able to perform wireless communication 22 with the central processing system 30 and wireless communication 26 with the PDA 20 according to known communication techniques such as infrared techniques, Bluetooth techniques, Bluetooth in combination with LAN network techniques, etc. Bluetooth techniques involve providing a small, inexpensive radio unit into mobile devices such as PDAs, mobile phones, PCs. Since the Bluetooth radio unit is designed according to a predetermined standard, it allows mobile devices having the Bluetooth radio units to communicate directly with each other when they come into range without the use of cables or network infrastructure. The Bluetooth standard defines protocols for establishing communication between two selected devices and/or multiple selected devices. Further information regarding the Bluetooth standard and technology is available at the website of http://www.bluetooth.com.

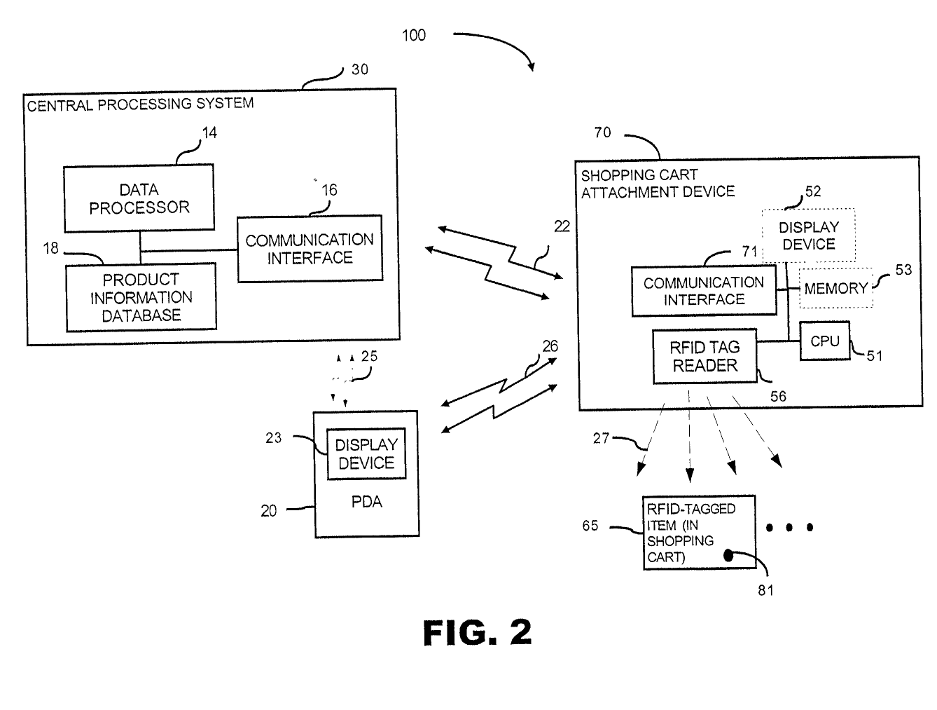

FIG. 2 is a block diagram of the system 100 illustrating the components of the system 100 in more detail according to one embodiment of the present invention. As shown in FIGS. 1 and 2, the shopping cart attachment device 70 includes a CPU (Central Processing Unit) 51, a display device 52 (optionally provided), memory 53 (optionally provided), a communication interface 71, and a RFID tag reader 56, all operatively coupled. The central processing system 30 includes a data processor 14, a communication interface 16, and a product information database 18, all operatively coupled. The PDA 20 includes the display device 23 and other components typically found in a conventional PDA, such as a processor, memory, user interfaces, an input device, etc. U.S. Pat. No. 5,974,238 to Chase, Jr., issued on Oct. 26, 1999, which is herein fully incorporated by reference, describes in detail the operation and components of a conventional PDA.

The communication interface 71 of the shopping cart attachment device 70 is configured to carry out the wireless communication 22 with the communication interface 16 of the central processing system 30, and the wireless communication 26 with the PDA 20. To provide the wireless communications 22 and 26, e.g., using Bluetooth techniques which provide short-range wireless communication, each of the PDA 20 and the communication interfaces 16 and 71 includes therein at least one Bluetooth radio unit known in the art. A Bluetooth radio unit includes both hardware (e.g., antenna, transmitter) and software for implementing short-range wireless communications.

The RFID tag reader 56 of the shopping cart attachment device 70 is a conventional RFID tag reader known in the art. The RFID tag reader 56 is configured to detect automatically all RFID-tagged items 65 as they are placed in and/or removed from the shopping cart 60 and to scan automatically the RFID tags 81 on these items 65. To ensure that only those items in the customer's shopping cart 60 are read and not the items outside the cart 60 (e.g., items placed on store shelves), the reading range of the RFID tag reader 56 is set to equal the area within the shopping cart 60. This can be accomplished using particular shapes or parameters for an antenna of the RFID tag reader 56, or using other known techniques or devices.

As the customer places RFID-tagged items 65 in and out of the customer's shopping cart 60 during his shopping process, the RFID tag reader 56 reads automatically the item information stored in the RFID tag of each item. No overt act is required by the customer to scan the RFID tag on the item, i.e., the mere act of placing the RFID-tagged item in the shopping cart 60 automatically triggers detecting of the item and reading of the RFID tag of the item. In this manner, all items currently placed in the shopping cart 60 are identified by and registered in the attachment device 70.

The operation of the system 100 is as follows. As the customer with the PDA 20 enters the store or other designated shopping area, the customer picks up a shopping cart such as the cart 60 having the shopping cart attachment device 70 mounted thereon. During the shopping process, the customer picks up certain items in the store and places them into the customer's shopping cart 60. The RFID tag reader 56 mounted on the shopping cart 60 automatically detects placement of the items into (and removal of the items from) the shopping cart 60 and automatically scans the RFID tags on such items. The scanned RFID tag information identifies information about the items placed in the cart 60 such as the name and price of the item, name of the manufacturer of the item, etc. Any scanned item information is transmitted continuously from the RFID tag reader 56 to the CPU 51 which in turn communicates it to the communication interface 71.

The communication interface 71 then transmits the received item information to the communication interface 16 of the central processing system 30 via the wireless communication 22. The data processor 14 then receives this item information and, based on the item information, retrieves certain product information from the product information database 17 or other storage unit. The retrieved product information identifies information helpful to the customer's shopping process, such as additional purchase suggestions associated with the items placed in the cart 60, locations or aisle numbers for the suggested purchase items, availability of coupons for the suggested purchase items, etc. The retrieved product information can further include nutritional information, expiration date and availability of coupons for the items in the shopping cart 60 and for the suggested purchase items. In fact, any information that will assist the customer in his or her shopping process can be provided to the customer based on the items placed in the shopping cart 60.

Then the retrieved product information including additional purchase suggestions are communicated to the shopping cart attachment device 70 via the wireless communication 22. The shopping cart attachment device 70 then displays this product information on the display device 23 of the customer's PDA 20 using the wireless communication 26.

As an example, if the customer places a bottle of spaghetti sauce in the shopping cart 60, then the data processor 14 is configured to display on the display device 23 a message identifying a list of recommended additional purchase items that are associated with the spaghetti sauce such as spaghetti noodles, garlic bread, etc. In another example, if the customer has selected a particular branded item such as IBM's Lexmark printer, then the message may indicate the names of printer cables that are required to operate this printer. The message may also identify the locations in the store where the recommended additional purchase items can be found, the price of these recommended items, any sale information associated with the recommended items, and any other information helpful to the customer for purchasing the recommended items.

In another embodiment, instead of transmitting helpful product information from the central processing system 30 to the customer's PDA 20 through the communication interface 71 of the shopping cart attachment device 70, it is possible to transmit this information from the central processing system 30 directly to the customer's PDA 20 via wireless communication 25 (FIG. 2) using known wireless communication techniques.

Since the shopping cart attachment device 70 reads all the RFID-tagged items placed inside the shopping cart 60, the shopping cart attachment device 70 can be configured easily to add up the prices of these items and to calculate the running total cost of these items which would be displayed on the customer's PDA 20 and/or the display device 52. This allows the customer to monitor his or her monetary spending as the customer shops.

In accordance with one embodiment, a “check-out” button or indicator is provided for managing the check-out process. This check-out button can be a button or switch physically located on the shopping cart attachment device 70 or can be a computer-generated button displayed on the display device 23 of the PDA 20. If the customer has completed his or her shopping and is ready to check out the items, the customer can actuate the check-out button on the attachment device 70 and/or on the PDA 20. This triggers communication with the store check-out system which displays a check-out message to the customer on the display device 23 and/or the display device 52. The check-out message provides to the customer certain check-out information such as the location or check-out lane number in the store where the payment for the carted items can be made by the customer. This process also alerts the store check-out system that a certain number of customers are ready for a check-out. This system can be used by the store manager or management system to manage workloads based on the store check-out traffic, available personnel, a number of items in each customer's shopping cart, etc.

In addition to the use of the check-out button, the system 100 is configured so that the check-out of all the items placed in the shopping cart 60 can be automatically and instantaneously performed by merely pushing the shopping cart 60 through the identified check-out lane (or other designated location) once the customer arrives at the identified check-out lane. This can be achieved easily by enabling a POS terminal or the like to communicate wirelessly with the shopping cart attachment device 70 which already has tabulated the running total price for the items contained in the shopping cart 60. This allows the customer to avoid going through long check-out lines as in prior art systems and provides a convenient and time-saving way to check out items from stores.

In another embodiment, any information (e.g., suggested additional purchase items, etc.) that is displayed on the display device 23 of the customer's PDA 20 can be displayed on the display device 52 (if provided) of the shopping cart attachment device 70 in lieu of or in addition to the display device 23. If, however, the information needs to be displayed only on the display device 23 of the PDA 20, the shopping cart attachment device 70 need not be equipped with a display device, and the size and the structure of the shopping cart attachment device 70 can be reduced and simplified.

In still another embodiment, the shopping cart attachment device 70 and the shopping cart 60 can be integrated into one component to produce an electronic shopping cart. The design, configuration and size of the electronic shopping cart can vary depending on the application and can be selected to optimize the use of the electronic components of the integrated shopping cart.

If the system 100 is implemented in a large area such as a shopping mall, the wireless communication 22 can be achieved by using a combination of Bluetooth and wired LAN (Local Access Network), a combination of Bluetooth and wireless LAN, or any other combination network capable of implementing the wireless communication 22 in large areas. Such networks allow the data processor 14 to communicate with the communication interface 71 of the shopping cart attachment device 70 wirelessly as the customer roams through the shopping malls or other large areas. Hardware and/or software configurations for implementing this kind of combination network are known in the art.

Although the present invention has been described in connection with using the PDA carried by a customer, any other wireless communication device carried by an individual, such as a mobile phone, a two-way pager, etc, can be used as long as it includes a display device and is capable of carrying out short-range wireless communication.

In one embodiment, the shopping cart attachment device 70 can be configured to carry out functions performed by the central processing system 30, i.e., the central precessing system 30 may be incorporated into the shopping cart attachment device 70. For instance, information stored in the database 18 may be stored in the shopping cart attachment device 70, e.g., in the memory 53 or other means accessible directly by the shopping cart attachment device 70, e.g., floppy discs, CD-ROM, etc. The CPU 51 can be configured to retrieve appropriate product information helpful to the customer's shopping process based on the RFID-tagged item information obtained from the RFID tag reader 56.

The processing steps of the present invention can be implemented by computer programs in conjunction with existing hardware components. Software programming code which embodies the present invention may be stored on any of a variety of known media such as a diskette, hard drive, CD-ROM, or read-only memory, and may be distributed on such media. The techniques and methods for embodying software programming code on physical media and/or distributing software code are known in the art.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A device for a shopping cart, the device comprising:
a communication interface capable of wireless communication with a wireless communication device;
a tag reader for automatically detecting a placement of an item into the shopping cart and automatically reading item Information tagged to the item; and
a processor for controlling the communication interface and the tag reader.

2. The device of claim 1, wherein the wireless communication device is one of the following: a personal digital assistant (PDA), a mobile phone, or a two-way pager.

3. The device of claim 1, wherein the item is a RFID-tagged item and the tag reader is a RFID tag reader capable of automatically reading the RFID-tagged item placed in the shopping cart.

4. The device of claim 3, wherein the communication interface wirelessly transmits the read item information to a central processing system and receives wirelessly from the central processing system certain product information associated with the RFID-tagged item placed in the shopping cart.

5. The device of claim 4, wherein the communication interface communicates wirelessly with the central processing system by using one of the following: Bluetooth communication techniques, infrared communication techniques, or a combination of Bluetooth communication techniques with LAN (Local Area Network) techniques.

6. The device of claim 4, wherein the product information identifies suggestive additional purchase items associated with the RFID-tagged item placed in the shopping cart.

7. The device of claim 6, further comprising:
a display device, coupled to the processor, for displaying the product information.

8. The device of claim 1, further comprising:
a check-out indicator for automatically communicating a check-out readiness status of a user of the shopping cart to a designated check-out management system.

9. The device of claim 8, further comprising:
a display device, coupled to the processor, for displaying a particular check-out location provided by the check-out management system in response to an actuation of the check-out indicator.

10. The device of claim 3, wherein the RFID tag reader automatically detects removal of the RFID-tagged item from the shopping cart.

11. A system for providing shopping assistance to a user, the system comprising:
a wireless communication device; and
a shopping cart attachment device for a shopping cart, including,
a communication interface capable of wireless communication with the wireless communication device,
a tag reader for automatically detecting placement of items into the shopping cart and automatically reading item information tagged to the items, and
a processing unit for controlling the communication interface and the tag reader.

12. The system of claim 11, wherein the wireless communication device is one of the following: a personal digital assistant (PDA), a mobile phone, or a two-way pager.

13. The system of claim 11, wherein the items are RFID-tagged items and the tag reader is a RFID tag reader capable of automatically reading the RFID-tagged items placed in the shopping cart.

14. The system of claim 13, wherein the RFID tag reader automatically detects removal of the RFID-tagged items from the shopping cart and the processing unit calculates a running total purchase price for the RFID-tagged items currently in the shopping cart.

15. The system of claim 11, further comprising:
a central processing system including,
a communication interface for communicating wirelessly with the communication interface of the shopping cart attachment device,
a data processor, coupled to the communication interface of the central processing system, for obtaining certain product information associated with the items placed in the shopping cart based on the item information.

16. The system of claim 15, wherein the communication interface of the central processing system communicates wirelessly with at least one of the wireless communication device and the communication interface of the shopping cart attachment device by using one of the following: Bluetooth communication techniques, infrared communication techniques, or a combination of Bluetooth communication techniques with LAN (Local Area Network) techniques.

17. The system of claim 15, wherein the central processing system further includes:
a database, accessible by the data processor, for storing the product information.

18. The system of claim 11, wherein at least one of the shopping cart attachment device and the wireless communication device includes:
a display device for displaying the product information.

19. The system of claim 15, wherein the product information identifies additional purchase items associated with the items placed in the shopping cart.

20. The system of claim 11, wherein the shopping cart attachment device includes a storage unit for storing information on different items, and the processing unit retrieves from the storage unit certain product information based on the items placed in the shopping cart, wherein the product information identifies additional purchase items associated with the items placed in the shopping cart.

21. The system of claim 11, wherein the shopping cart attachment device further includes:
a check-out indicator for automatically communicating a check-out readiness status of the user to a designated check-out management system.

22. The system of claim 21, wherein the shopping cart attachment device further includes:
a display device, coupled to the processing unit, for displaying a particular check-out location provided by the check-out management system in response to an actuation of the check-out indicator.

23. The system of claim 11, wherein the wireless communication device includes:
a check-out indicator for automatically communicating a check-out readiness status of the user to a designated check-out management system.

24. The system of claim 23, wherein at least one of the shopping cart attachment device and the wireless communication device includes:
a display device for displaying a particular check-out location provided by the check-out management system in response to an actuation of the check-out indicator.

25. A method of providing shopping assistance to a user using a shopping cart attachment device associated with a shopping cart operated by the user, the method comprising the steps of:
automatically detecting, by the shopping cart attachment device, a placement of an item into the shopping cart;
automatically reading item information tagged to the item; and
providing certain product information associated with the item to the user to provide shopping assistance to the user.

26. The method of claim 25, wherein the reading step includes:
automatically scanning a RFID tag on the item.

27. The method of claim 25, wherein the product information identifies additional purchase items associated with the item placed in the shopping cart.

28. The method of claim 27, wherein the providing step includes:
wirelessly communicating the item information to a central processor,
retrieving, by the central processor, the product information associated with the item based on the item information, and
displaying the retrieved product information to the user.

29. The method of claim 28, wherein, in the displaying step, the retrieved product information is displayed on a wireless communication device carried by the user.

30. The method of claim 29, wherein the wireless communication device is one of the following: a personal digital assistant (PDA), a mobile phone, or a two-way pager.

31. The method of claim 28, wherein, in the communicating step, the item information is communicated wirelessly by using one of the following: Bluetooth communication techniques, infrared communication techniques, or a combination of Bluetooth communication techniques with LAN (Local Area Network) techniques.

32. The method of claim 28, wherein the shopping cart attachment device includes a display device, and wherein, in the displaying step, the retrieved product information is displayed on the display device.

33. The method of claim 27, further comprising:
providing a check-out indicator on one of the shopping cart attachment device and the wireless communication device;
automatically communicating a check-out readiness status of the user to a designated check-out management system in response to an actuation of the check-out indicator by the user; and
indicating a particular check-out location to the user as provided by the check-out management system.

34. The method of claim 27, further comprising:
automatically detecting a removal of the item from the shopping cart;
calculating a running total purchase price for all items currently placed in the shopping cart, and
displaying the running total purchase price to the user.

35. A computer program product embodied on computer readable media readable by a computer system associated with a shopping cart, for providing shopping assistance to a user, the computer program product comprising computer executable instructions for:
controlling an automatic detection of a placement of an item into, and a removal of an item from, the shopping cart;
controlling an automatic reading of item information tagged to the item; and
providing certain product information associated with the item to the user to provide shopping assistance to the user.

36. The computer program product of claim 35, wherein the automatic reading of the item information is performed by automatically scanning a RFID tag on the item.

37. The computer program of claim 35, further comprising computer executable instructions for:
calculating a running total purchase price of all items currently in the shopping cart; and
displaying the running total purchase price to the user.

38. The computer program product of claim 36, wherein the product information identifies additional purchase items associated with the item placed in the shopping cart.

39. The computer program product of claim 38, wherein the computer executable instructions for providing the product information include computer executable instructions for:
wirelessly communicating the item information to a central processor,
retrieving, by the central processor, the product information associated with the item based on the item information, and
displaying the retrieved product information to the user.

40. The computer program product of claim 39, wherein the retrieved product information is displayed on a wireless communication device carried by the user.

41. The computer program product of claim 40, wherein the wireless communication device is one of the following: a personal digital assistant (PDA), a mobile phone, or a two-way pager.

42. The computer program product of claim 39, wherein the item information is communicated wirelessly by using one of the following: Bluetooth communication techniques, infrared communication techniques, or a combination of Bluetooth communication techniques with LAN (Local Area Network) techniques.

43. The computer program product of claim 35, further comprising computer executable instructions for:
automatically communicating a check-out readiness status of the user to a designated check-out management system in response to an actuation of a check-out indicator by the user; and
displaying to the user a particular check-out location provided by the check-out management system.
